(19) United States
(12) Patent Application Publication
(10) Pub. No.: US 2009/0269439 A1
(43) Pub. Date: Oct. 29, 2009

(54) PROCESS FOR PREPARING A HIGHLY-SOLUBLE COCOA EXTRACT

(75) Inventors: Leila MOULAY, Quart de Poblet (ES); Zachary Sniderman, Quart de Poblet (ES); Alvin Ibarra, Quart de Poblet (ES); Vicente Marti-Bartual, Quart de Poblet (ES)

Correspondence Address: SUGHRUE MION, PLLC, 2100 PENNSYLVANIA AVENUE, N.W., SUITE 800, WASHINGTON, DC, 20037, US

(73) Assignee: NATRACEUTICAL S.A.

(21) Appl. No.: 12/325,410

(22) Filed: Dec. 1, 2008

Related U.S. Application Data
(63) Continuation of application No. 11/913,564, now abandoned.

(30) Foreign Application Priority Data
May 5, 2005 (ES) P200501080

(51) Int. Cl. A23G 1/56; A23G 1/02

(52) U.S. Cl. 426/45

(57) ABSTRACT

The invention relates to a method of obtaining a highly-soluble extract from cocoa husk and/or bark. The end product, which is rich in dietary fibre, is ideal for use in chocolate, bread-making, drinks, snacks, diary products and confectionery goods.

### CROSS-REFERENCE TO RELATED APPLICATIONS

This application is a Continuation of U.S. application Ser. No. 11/913,564, filed Nov. 5, 2007; which is a 371 of PCT/ES2005/000377, filed Jul. 1, 2005; the entire disclosure of each of which is incorporated herein by reference.

### DESCRIPTION

The object of the present invention, as declared in the title of this specification, consists of a “Process for preparing a highly soluble cocoa extract” of the type used as a complement in foods, nutraceuticals, dietary supplements and functional foods.

### BACKGROUND

During the cocoa powder manufacturing process, the bean is fermented, dried and cleaned before being separated into husk and nibs. The nibs continue in the cocoa powder manufacturing process, whilst the husk is separated off to be used for other purposes. The husk represents approximately 12.5% of the cocoa bean.

The husk contains more than 40% dietary fibre (20% cellulose, 12% hemicellulose and 12% galacturonic acids). The husk also contains protein (15%), lignin (13%, Klason method), minerals (13%), lipids (2%), carbohydrates (2% as starches and sugars), theobromine (1%), and other compounds such as polyphenols, tannins and caffeine.

Cocoa husk is a product that has recently been used for various applications in food and pharmaceuticals.

In some processes for the production of cacao butter alone, pressing systems (hydraulic or expeller systems) are used to separate the cocoa butter from the bean. The process produces cocoa butter and also a by-product that is a mixture of partially defatted husk and nibs. This by-product is commonly known as press cake.

The press cake contains approximately 45% dietary fibre (6% soluble and 39% insoluble). It also contains proteins (24%), fats (12%), and other minority compounds such as polyphenols, theobromine and caffeine.

Some patents protect applications of the husk and the press cake for manufacturing products for use in foods and pharmaceuticals. These do not, however, affect the invention disclosed herein.

Patent ES 2099676B1 protects an ingredient for food and pharmaceuticals for human consumption, mainly in the dietary area. This ingredient is based on toasting of the husk, and it also discloses its nutritional composition. However, this document does not specify whether the husk has previously been treated or the process conditions used to produce the ingredient.

U.S. Pat. No. 0,052,910 explains the method of producing a soluble cocoa fibre using the husk, using an aqueous extraction. In this process, the inventors use hot water for the extraction at a temperature of between 100° C. and 130° C. No catalysts of any type are used in the process. The soluble fibre is then purified using activated carbon treatments, resin treatments, UF concentration, solvent precipitation, and finally mineral separation by dialysis or with an ion exchange resin. This product is designed for application with proteins in food, such as milk-based beverages, stabilisers for cocoa beverages, coating agents with a wide range of applications, age resistors for starch-containing foods, and shelf-life extenders for foods and beverages.

U.S. Pat. No. 4,948,600 covers a process for producing a product that is rich in dietary fibre using conventional cocoa powder. In this invention the product is obtained by removing the starch from the cocoa powder. The starch is enzymatically degraded, and then extracted with continuous washing using a separating operation. Finally, the low-in-starch cocoa is dried. This process produces a product with a dietary fibre content of between 35% and 75%. In this product the concentration of insoluble fibre is greater than the content of soluble fibre. The end product is suitable for producing e.g. chocolate enriched with dietary fibre, chocolate beverages enriched with dietary fibre, chocolate sauces enriched with dietary fibre, and desserts enriched with dietary fibre.

U.S. Pat. No. 4,156,030 covers a process for producing an extract from the husk using acidified ethanol. In this process, the husk is ground and the extraction is carried out at reflux temperature, the solution containing between 80% and 90% ethanol and 10% to 15% acid (hydrochloric, phosphoric, citric or tartaric). After extraction, the ethanol is evaporated and the concentrate is dried.

Patent WO 004619A3 relates to a process for producing cocoa powder from press cake. In this process, the entire cocoa bean is partially defatted by pressing to produce a press cake with a fat content of 10% to 12%. Optionally, the press cake can be completely defatted using organic solvents or by supercritical extraction with CO2. Finally, the press cake is ground to produce cocoa bean powder.

The present invention proposes an innovative process for producing a highly soluble extract using cocoa bean husk or press cake (defatted bean), or a mixture of the two. In this process, the microbial load in the raw material is reduced by using over-saturated steam. Then the raw material is mixed with water and is enzymatically treated. The purpose of the enzymatic treatment is to aid the hydrolysis of the insoluble fraction with a consequent increase in the soluble components during the aqueous extraction. The temperature of the enzymatic reaction and extraction is below 100° C. After the extraction process, the solids are separated from the highly soluble fraction using centrifuge technology (decanter and clarifiers). The highly soluble cocoa husk/press cake extract is then dried and optionally ground.

The purpose of the product is for application in foods, nutraceuticals, dietary supplements, and functional foods. The main characteristic of this product is its high solubility, and its nutritional and sensory profile. The principal nutritional compounds are soluble fibre, minerals, proteins, polyphenols and theobromine. The sensory profile of the product is similar to that of cocoa. This product is ideal for application in chocolate, bakery products, beverages, snacks, dairy products and confectionery.

### DESCRIPTION OF THE INVENTION

The invention is a process wherein a highly soluble extract is produced from cocoa husk and/or press cake as sources of the raw material.

In the invention, the raw material is sterilised in reactors that are designed to withstand high temperatures and pressures. Direct or indirect over-saturated steam can be used as a heat source to reach temperatures of more than 100° C. and high pressures in the reactor; e.g. 140° C. and 1.5 bars. The sterilisation time is preferably more than 5 minutes, e.g. 30 minutes.

After the sterilisation step, the product is subjected to a process of enzymatic hydrolysis. To carry out this process, the sterilised raw material is mixed with water. The list of raw materials: a suitable amount of water is between 1:5 and 1:15, e.g. 1:7. Then the temperature for the process is stabilised at between 50° C. and 70° C. Under these conditions, the pH of the mixture is between 4.5 and 5.6. Once the mixture has been thoroughly mixed; an enzyme with predominantly beta-glucanase activity is added. The enzyme is added to the mixture in an approximate concentration of 0.01 Fungal Beta-Glucanase units (FBG) or more per kilogram of cocoa raw material. The reaction time of the enzyme is 1 to 3 process hours, e.g. 2 process hours. The reaction time is directly related to the amount of enzyme that is added; the more enzyme that is added, the shorter the reaction time. Too much or too little stirring may be detrimental to the reaction; therefore, the rate of stirring must be graduated so that the reaction takes place under the best possible process conditions. Furthermore, the enzyme should preferably be inactivated after the enzymatic reaction is completed. This inactivation may be carried out after the hydrolysis operation or at a subsequent step in production.

After the enzymatic hydrolysis, the mixture is centrifuged in order to separate the soluble fraction.

The total solids are defined as the sum of the solids in suspension and the soluble solids. Soluble solids are technologically defined as particles with a particle size of less than 5 microns. Therefore, to produce a soluble product, all particles in suspension that are larger than 5 microns must be separated.

The separating operation may be carried out in two steps: a centrifuging step and an optional clarifying step. All the solids larger than 20 microns are separated in the centrifuging step, whilst the remaining solids in suspension that are larger than 5 microns are separated in the clarifying step.

Prior to separation, it is recommended that the mixture should be cooled to below 55° C., e.g. 40° C. to aid separation. The cooled mixture is then centrifuged to produce a solid phase and a liquid phase. The solid phase is discarded. Industrial decanters may be used in the centrifuging process, e.g. those of the FP series by Pieralisi (i.e. FP600 2RS).

In the optional clarifying step, vertical plate clarifiers may be used, e.g. those supplied by Alfa Laval or Westfalia Separator. It is also possible to clarify the liquid phase from the decanter using microfiltration systems, such as those supplied by GEA.

The liquid phase resulting from the centrifuging operations has a total solids content of between 1 and 5%.

After the separation step, the liquid phase is concentrated. During concentration, the liquid phase is concentrated to achieve a total solids concentration of more than 10%, e.g. 30%. This operation may be completed using single, double or triple phase concentrators, at temperatures of between 60° C. and 100° C., preferably under vacuum conditions.

The concentrate then undergoes a drying step. The objective of this step is to produce a product with a moisture content of less than 10%, e.g. 5% moisture.

The product may be dried using a spray dryer at temperatures above 75° C., e.g. 130° C. If necessary, vacuum may be used during the operation. If a spray dryer is used, it is not necessary to grind the product. However, if another drying system is used, e.g. horizontal or vertical strip dryers, it is necessary to perform a final grinding of the product. These dryers may operate in normal conditions or under vacuum. The enzyme may also be inactivated in this operation by subjecting the product to temperatures above 90° C. for 10 minutes.

The end product is a highly soluble cocoa husk and/or press cake extract in powder form, the particle size of which will preferably be below 100 microns in 99%.

### DESCRIPTION OF A PRACTICAL CASE

### Example 1

### Microbiological Reduction Using Over-Saturated Steam

In this example, the cocoa husk was treated with over-saturated steam in order to reduce the microbial load. The raw material was analysed to determine the Enterobacteriaceae and fungi and yeast content; the values for both indicators were greater than 300,000 cfu/g. The heat treatment was carried out in a reactor by applying the steam directly to the raw material. The process conditions were 1.5 bars and 140° C. for 30 minutes. After the heat treatment, the microbiological content of the raw material was analysed again. The results are shown in table 1; as can be seen, the microbiological reduction was significant.

TABLE 1
Microbiological content after sterilisation

| Microbiological indicator | Count |
|---|---|
| Total count1 | 730 cfu/g |
| Fungi and Yeast2 | ≦100 cfu/g |

References and methods:

(1) AOAC International. Official Methods of Analysis, 17th ed., AOAC

International, Arlington, Va., 2003

(2) AOAC International. Official Methods of Analysis, 17th ed., AOAC

International, Arlington, Va., 2003.

### Example 2

### Processes and Yields

900 kg of husk was treated according to the conditions explained in example 1. Then it was mixed with water at a concentration of 1:11 husk:water, the final temperature of the mixture being 20° C. The mixture was then heated to 55° C. and 360 g of the commercial enzyme Ultraflo L (novozyme) was added. The mixture was gently stirred for 1.5 hours. After the hydrolysis, the mixture was cooled to 40° C. to produce the solid phase after separation by centrifuging and clarifying. The liquid fraction was then concentrated at 60° C. in a triple effect concentrator, and dried in a spray dryer with an input temperature of the concentrate of 140° C. and an output temperature of the dry product of 90° C. Finally, an extract in powder form with high solubility was produced. The balance of materials during the process can be observed in table 2.

TABLE 2
Yields during production of the Husk Extract

| | kg | % |
|---|---|---|
| Operation | | |
| Husk | 900 | 100 |
| Water | 10100 | |
| Separation | | |
| Liquid phase | 9504 | 86.4 |
| Solid phase | 1495.27 | 13.6 |
| End product | 188 | 20.8 |

### Example 3

### Nutritional and Hygiene Quality Profile of the End Product

Table 3 shows some of the compounds analysed in the cocoa husk extract. Table 4 shows the microbiological load in the end product.

TABLE 3
Nutritional profile

| Compound | g/100 g of sample |
|---|---|
| Moisture^{a} | 3.51 |
| Total dietary fibre^{b} | 46.50 |
| Soluble fibre | 42.80 |
| Insoluble fibre | 3.70 |
| Fat^{c} | 1.40 |
| Total sugars^{d} | 1.91 |
| Minerals^{e} | 15.00 |
| Proteins^{f} | 13.10 |
| Theobromine^{g} | 3.40 |
| Caffeine^{g} | 0.19 |
| Polyphenols^{h} | 2.24 |

References and methods
^{a}Spanish Pharmacopoeia 1997; European Pharmacopoeia 2nd Ed.
^{b}AOAC Method 99143, 17th Ed., 2000, enzymatic-gravimetric method
^{c}AOAC Method 96315, 17th Ed., 2000
^{d}Official European Community method CONSLEG; 1971 L0250-26/05/1999
^{e}Spanish Pharmacopoeia 1997; European Pharmacopoeia 2nd Ed.
^{f}AOAC Official Method 97022, 17th Ed.
^{g}AOAC Official Method 98014, 17th Ed.
^{h}Analysis of Total Phenolic and Other Oxidation Substrates and Antioxidants by Means of Folin-Ciocalteu Reagent. Methods in Enzymology, Oxidants and Antioxidants, Part A, Lesler Packer (ed) (199), 299, 152-178 (ISBN 0121822001). Academic Press, San Diego.

TABLE 4
Microbiological profile

| | | |
|---|---|---|
| Total count | 1500 | cfu/g |
| Moulds and Yeasts | <10 | cfu/g |
| Enterobacteriaceae | <10 | cfu/g |
| Coliforms | <3 | MPN |

| | |
|---|---|
| E. coli | Absence in 1 g |
| Salmonella | Absence in 25 g |

Having established the stated concept, the claims are given below, thus summarising the novelties to be claimed:

1. A process for preparing a highly soluble cocoa extract comprising:
a. sterilizing cocoa raw material,
b. mixing said sterilized cocoa raw material with water,
c. enzymatically treating in order to aid extraction of soluble components, and creating a solid part and a liquid part,
d. separating the solid phase and liquid phase,
e. concentrating the liquid phase, and
f. drying the resulting concentrate from the liquid phase.

2. The process according to the claim 1, further comprising grinding a dry concentrate made from the liquid phase.

3. The process according to claim 1, wherein the cocoa raw material consists of cocoa husks separated from cocoa beans.

4. The process according to claim 1, wherein the cocoa raw material consists of a cocoa press cake.

5. The process according to claim 1, wherein the cocoa raw material consists of a whole cocoa bean product.

6. The process according to claim 1, wherein the cocoa raw material consists of a mixture of two of products selected from the group consisting of cocoa husks, a cocoa press cake and a whole cocoa bean product.

7. The process according to claim 1, wherein the cocoa raw material consists of a mixture of cocoa husks, a cocoa press cake and a whole cocoa bean product.

8. The process according to claim 1, wherein the cocoa raw material is sterilized by over-saturated steam at temperatures above 100° C. for more than 5 minutes.

9. The process according to claim 1, wherein the cocoa raw material is sterilized by over-saturated steam at temperatures at 150° C. for 30 minutes.

10. The process according to claim 1, wherein the cocoa raw material is mixed in a proportion of between 1:5 parts and 1:15 parts of cocoa raw material:water, and wherein mixing is carried out at a stabilized temperature of between 50° C. and 70° C.

11. The process according to claim 1, wherein the cocoa raw material is mixed in a proportion of 1 part cocoa raw material to 7 parts water.

12. The process according to claim 1, wherein an enzyme is added to the cocoa:water mixture in a concentration of at least 0.005 Fungal Beta-Glucanase units (FBG) per kg of cocoa raw material.

13. The process according to claim 1, wherein an enzyme is added to the cocoa:water mixture in a concentration of 0.01 Fungal Beta-Glucanase units (FBG) per kg of cocoa raw material.

14. The process according to claim 1, wherein the enzymatic reaction takes place for a period of between 1 and 3 hours.

15. The process according to claim 1, wherein the enzymatic reaction takes place for a period of 2 hours.

16. The process according to claim 1, wherein the separation of the cocoa and water mixture to produce a liquid phase and a solid phase is carried out using a centrifuge.

17. The process according to claim 1, wherein solids in suspension of up to 20 microns that are present in the liquid phase are removed using a decanter.

18. The process according to claim 1, wherein solids in suspension of up to 5 microns that are present in the liquid phase are removed using a clarifier.

19. The process according to claim 16, wherein the liquid phase produced after centrifuging is concentrated to achieve a value of between 10% and 50% total solids.

20. The process according to claim 16, wherein the liquid phase produced after centrifuging is concentrated to achieve a value of 16% total solids.

21. The process according to claim 1, wherein the liquid phase is concentrated using concentrators within a temperature range of between 60° C. and 100° C.

22. The process according to claim 1, wherein the liquid phase is concentrated using concentrators at a temperature of 75° C.

23. The process according to claim 1, wherein the liquid phase is concentrated under vacuum conditions at pressures below 200 mbar.

24. The process according to claim 1, wherein the concentrated liquid phase is dried to less than 10% moisture.

25. The process according to claim 1, wherein the concentrated liquid phase is dried to less than 5% moisture.

26. The process according to claim 1, wherein the concentrated liquid phase is dried to a minimum of 3% moisture.

27. The process according to claim 1, wherein the drying is carried out at normal pressure or under vacuum conditions, and at a temperature above 60° C. and below 150° C.

28. The process according to claim 1, wherein the drying is carried out at normal pressure or under vacuum conditions, and at a temperature of 100° C.

29. The process according to claim 1, wherein drying is carried out using an aerosol dryer.

30. The process according to claim 1, wherein drying is carried out using a vertical, horizontal or vacuum dryer.

31. The process according to claim 1, wherein the dry product is pressed to produce a product with 99% of the particles being smaller than a maximum of 300 microns.

32. The process according to claim 1, wherein the dry product is pressed to produce a product with 99% of the particles being smaller than 100 microns.

33. The process according to claim 1, wherein enzyme is inactivated at temperatures above 90° C.

34. The process according to claim 1, wherein the end product is a cocoa extract rich in soluble dietary fibres that is suitable as a chocolate complement, in bakery products, beverages, snacks, dairy products, or desserts.
